(19) United States
(12) Patent Application Publication
(10) Pub. No.: US 2014/0032421 A1
(43) Pub. Date: Jan. 30, 2014

(54) Display Controller, Display Control Method And Computer-Readable Medium

(71) Applicant: P&W Solutions Co., Ltd., Tokyo (JP)

(72) Inventor: Toshiyuki Omiya, Tokyo (JP)

(21) Appl. No.: 13/950,857

(22) Filed: Jul. 25, 2013

(30) Foreign Application Priority Data
Jul. 26, 2012 (JP) 2012-165998

(51) Int. Cl. G06Q 30/00

(52) U.S. Cl. CPC G06Q 30/016
USPC 705/304

(57) ABSTRACT

A display image generation unit (59) generates a portion changed within a sheet image on the top as data of a display image in a case in which there is a change operation by an in-sheet display area change unit (57), and generates data of an image showing a state in which sliding is gradually performed from a sheet image layered on the top to a sheet image subsequently layered as data of a display image in a case in which there is a change operation by a between-sheet display area change unit (58). A display controller (60) executes to control to display a display image generated as data on a display area of a display device (17).

This application is based on and claims the benefit of priority from Japanese Patent Application No. 2012-165998, filed on 26 Jul. 2012, the content of which is incorporated herein by reference.

### BACKGROUND OF THE INVENTION

1. Field of the Invention

The present invention relates to a display controller, and a display control method, and computer-readable medium.

2. Related Art

In recent years, a management method known as WFM (Workforce Management) has gained attention, which adjusts balance between service quality to be ensured and labor cost. Such WFM is implemented at a contact center (a call center) that serves as a technical support desk for customers. In other words, such WFM is implemented at a contact center in which efficient use and deployment of workforce is achieved by predicting the required number of staff in advance based on an analysis of operation status of each operator, for the purpose of maintaining the quality of response to customers while curbing labor cost.

Sweet Series provided by the applicant is widely known as a tool suitable for WFM, and is employed for efficient use, deployment, and the like of a workforce by displaying information such as past call volume and response results in an easily understandable manner visually.

Japanese Unexamined Patent Application, Publication No. 2010-102662 discloses a conventional display controller that is preferable for such WFM. The display controller disclosed in Japanese Unexamined Patent Application, Publication No. 2010-102662 changes the content that is displayed on a display area of a display unit, for example, a display target portion of a display image, at an interval of touch operations.

### SUMMARY OF THE INVENTION

The display controller disclosed Japanese Unexamined Patent Application, Publication No. 2010-102662 is not configured to deal with a plurality of sheet images. Therefore, a display controller used in WFM has been required in which a plurality of sheet images is layered; one thereamong is displayed as a display target; and upon a predetermined operation, a sheet image as a display target is changed. Furthermore, as disclosed in Japanese Unexamined Patent Application, Publication No. 2010-102662, it has been required to change a display area within a sheet image (including zooming in and out). Moreover, it has been required to change a sheet image as a display target, i.e. change a display area between sheet images with an intuitive and easy operation without erroneous operation.

However, conventional technologies including Japanese Unexamined Patent Application, Publication No. 2010-102662 cannot sufficiently address such various requirements.

The present invention has been made taking account of such a situation, and it is an object of the present invention to realize changing a display area within a sheet image and changing a display area between sheet images with an intuitive operation without an erroneous operation in a case of layering a plurality of sheet images and display one from among the plurality of sheet images as a display target.

In order to achieve the object, a display controller according to an aspect of the present invention includes: a sheet image generation unit that generates data of a plurality of sheet images; a sheet image layering unit that layers, in a predetermined order, data of the plurality of sheet images generated by the sheet image generation unit; a switching operation receiving unit that receives an operation to switch between an active state in which a change within a sheet image is permitted and a hold state in which the change is prohibited, for a display area of a predetermined display device; a display change operation receiving unit that receives an operation to instruct a change of display contents of the display device; an in-sheet display area change unit that functions in a case of being in the active state, and changes a display area of the display device within a range of a sheet image layered on the top, based on contents of the operation received by way of the display change operation receiving unit; a between-sheet display area change unit that functions in a case of being in the hold state, and changes a display area of the display device so as to gradually slide from a sheet image layered on the top to a sheet image subsequently layered, based on contents of an operation received by the display change operation receiving unit; a display image generation unit that, in a case of there being a change operation by way of the in-sheet display area change unit, generates a portion changed within a sheet image on the top as data of a display image, and in a case of there being a change operation by way of the between-sheet display area change unit, generates data of an image showing an aspect of gradually sliding from a sheet image layered on the top to a sheet image subsequently layered, as data of a display image; and a display control unit that executes control to display the display image generated as data by the display image generation unit on a display area of the display device.

According to the present invention, it is possible to realize changing a display area within a sheet image and changing a display area between sheet images with an intuitive operation without an erroneous operation in a case of layering a plurality of sheet images and display one from among the plurality of sheet images as a display target.

### BRIEF DESCRIPTION OF THE DRAWINGS

FIG. 1 is a block diagram showing a hardware configuration of a display controller to which an embodiment of the present invention is applied;

FIG. 2 is a functional block diagram showing a function configuration for executing active/hold display processing among the functional configurations of the display controller of FIG. 1;

FIG. 3 is a diagram showing respective outlines of a change within a sheet image and a change between sheet images on a display area in active/hold display processing;

FIG. 4 is a diagram showing an example of a screen transition at the time of a change between sheet images of a display area in active/hold display processing;

FIG. 5 is a state transition diagram showing a screen transition of a display unit in active/hold display processing;

FIG. 6 is a diagram showing an example of a screen of a display unit on which a first sheet image in an initial state is displayed in active/hold display processing;

FIG. 7 is a diagram showing an example of a screen of a display unit on which a first sheet image that is after a change of a display area within a sheet image is made in active/hold display processing is displayed;

FIG. 8 is a diagram showing an example of a screen of a display unit in a state of being during a change of a display area between sheet images being made in active/hold display processing; and

FIG. 9 is a diagram showing an example of a screen on a display unit after a change of a display area between sheet images is performed in active/hold display processing.

### DETAILED DESCRIPTION OF THE INVENTION

Descriptions of an embodiment of the present invention are hereafter provided with reference to the drawings as appropriate.

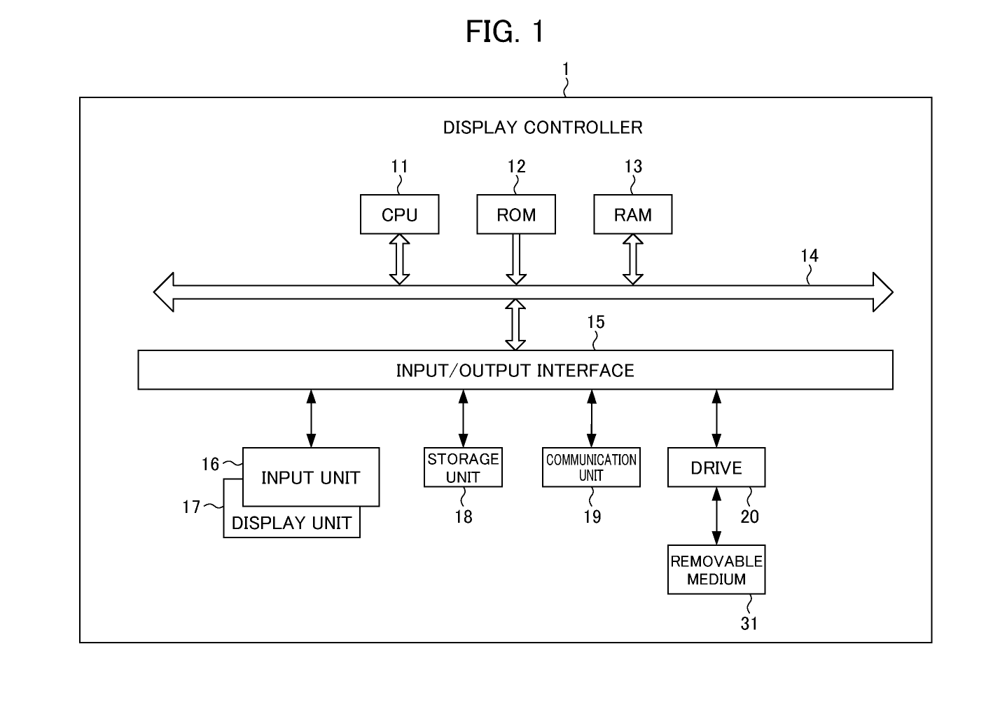

FIG. 1 is a block diagram showing a hardware configuration of a display controller to which an embodiment of the present invention is applied.

A display controller 1 is configured as, for example, a touch screen tablet.

The display controller 1 includes: a CPU (Central Processing Unit) 11, ROM (Read Only Memory) 12, RAM (Random Access Memory) 13, a bus 14, an input/output interface 15, an input unit 16, a display unit 17, a storage unit 18, a communication unit 19, and a drive 20.

The CPU 11 executes various types of processing in accordance with programs recorded in the ROM 12 or programs loaded into the RAM 13 from the storage unit 18.

The RAM 13 appropriately stores data, etc. required for the CPU 11 to execute various types of processing.

The CPU 11, the ROM 12 and the RAM 13 are mutually connected via the bus 4. The input/output interface 15 is also connected to the bus 14. The input unit 16, the display unit 17, the storage unit 18, the communication unit 19 and the drive 20 are connected to the input/output interface 15.

The input unit 16 is configured to include a capacitive or resistive touch screen that is laminated on a display screen of the display unit 17. The touch screen detects coordinates of a position where a touch operation is performed (hereinafter referred to as “touch position”). In this regard, the touch operation refers to an operation of an object (a finger or stylus of a user) to touch or approach the touch screen.

The display unit 17 is configured by a display to display various images.

The storage unit 18 is configured by a hard disk or DRAM (Dynamic Random Access Memory), and stores data of various images.

The communication unit 19 controls communication with other devices (not shown) via networks including the Internet.

A removable medium 31 is mounted to the drive 20 as appropriate. The removable medium 31 is composed of a magnetic disk, an optical disk, a magneto-optical disk, semiconductor memory, or the like. The drive 20 reads a program(s) from the removable medium 31. The program(s) is installed in the storage unit 18 as necessary. Similar to the storage unit 18, the removable medium 31 can also store a variety of data such as image data stored in the storage unit 18.

The display controller 1 with such a configuration can layer a plurality of sheet images and display on the display unit 17 a sheet image as a display target (one sheet image except for while changing).

A specific example for a sheet image is described later. In the present embodiment, the display controller 1 displays on the display unit 17 a sheet image used by application software for managing a human resource such as phone operators based on call volume and the like, for example. Such a sheet image includes a sheet image that schematically displays a phone operator who is currently on a call along with a seating arrangement, a sheet image that schematically displays a change in call volume on a graph, etc.

Furthermore, the display controller 1 can layer a plurality of sheet images and execute active/hold display processing with a sheet image as a display target being displayed on the display unit 17.

Here, “active state” refers to a state in which a change of a display area within a sheet image as a display target is permitted and “hold state” refers to a state in which a change of a display area within a sheet image as a display target is prohibited. “Active/hold display processing” refers to processing in which active display processing is combined with hold display processing. “Active display processing” refers to a sequence of processing of: entering an active state; changing a display area within a sheet image; and displaying a display area thus changed on the display unit 17. “Hold display processing” refers to a sequence of processing of: entering a hold state; dynamically displaying on the display unit 17 an event during which a sheet image currently displayed as a display target is changed to a sheet image different from the sheet image currently displayed as a display target; and displaying the different sheet image at the end.

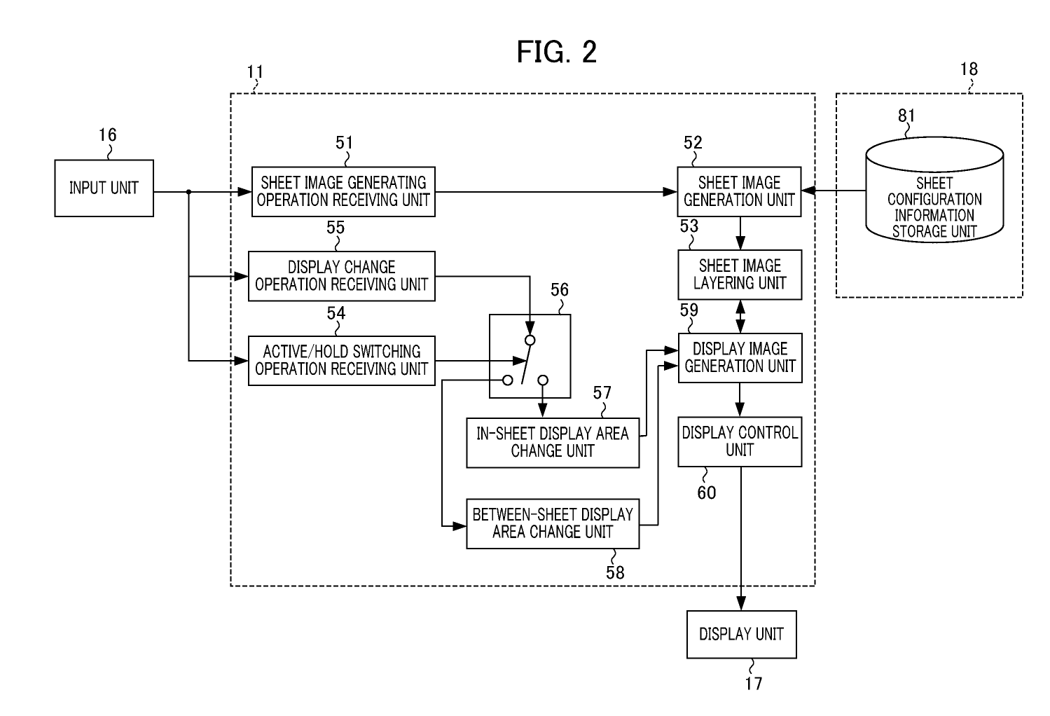

FIG. 2 is a functional block diagram showing a functional configuration for executing the active/hold display processing among the functional configurations of the display controller of FIG. 1.

In a case in which the execution of the active/hold display processing is controlled, a sheet image generating operation receiving unit 51, a sheet image generation unit 52, a sheet image layering unit 53, an active/hold switching operation receiving unit 54, a display change operation receiving unit 55, a switching unit 56, an in-sheet display area change unit 57, a between-sheet display area change unit 58, a display image generation unit 59, and a display control unit 60 function in the CPU 11.

It should be noted that the sheet image generation unit 52 through the between-sheet display area change unit 58 functioning in the CPU 11 is merely an example. In other words, at least some of the functions of the sheet image generation unit 52 through the between-sheet display area change unit 58 can also be assigned to components other than the CPU 11 (for example, a special purpose processor for image processing, etc.).

A sheet configuration information storage unit 81 is provided in an area of the storage unit 18.

In the sheet configuration information storage unit 81, various information necessary for generating data of a sheet image, for example, various information such as table data necessary for drawing a graph, personal information of phone operators and icon parts, are stored.

The sheet image generating operation receiving unit 51 receives an operation to select a sheet image arbitrarily generated by a user (hereinafter, referred to as “sheet image generating operation”) from among a plurality of kinds of sheet images as candidates. The sheet image generating operation receiving unit 51 notifies a result selected to the sheet image generation unit 52.

The sheet image generation unit 52 generates data of a plurality of kinds of sheet images arbitrarily selected by a user based on data of various information stored in the sheet configuration information storage unit 81.

It should be noted that, although the kind and the number of sheet images generated by the sheet image generation unit 52 are not limited in particular, for the purpose of simplicity in explanation, three predetermined kinds thereof are selected by a user for an example. Therefore, in a case in which it is necessary to distinguish each of the three types of sheet images from each other, they are called “first sheet image”, “second sheet image”, and “third sheet image”, respectively.

The sheet image layering unit 53 layers data of the three types of sheet images from the first sheet image to the third sheet image generated by the sheet image generation unit 52 in a predetermined order (including a circulating order described later). In other words, the sheet image layering unit 53 manages a layering relationship among the sheet images such as an order of overlapping each of the three types of the sheet images.

More specifically, for example, an order of the sheet image generation unit 52 generating sheet images is a first sheet image, a second sheet image, and third sheet image in the order from newest sheet image. In this case, the sheet image layering unit 53 layers of the respective data in the order generated by the sheet image generation unit 52 in an initial state, i.e. the order of the first sheet image, the second sheet image, and the third sheet image (or sets such a layering relationship of sheet images).

In this way, in the initial state, the first sheet image is displayed in full-screen on the display unit 17 as a display target, thereby enabling a display change from the first sheet image to the second sheet image.

In a case in which there is a display change between the sheet images (described later), the sheet image layering unit 53 changes the layering order and layers of the respective data of the first sheet image, the second sheet image, and the third sheet images again.

Here, although a method of changing a layering order is not limited in particular, it is possible for the sheet images to move in circulation (rotation) in the present embodiment. Therefore, for the sheet images as a display target (sheet image layered on the top), the layering order is changed from the top to the bottom, and for the remaining sheets, the layering order is changed so as to increment by 1.

More specifically, for example, in a case in which there is a display change from the first sheet image to the second sheet image in the abovementioned initial state, the layering order of the first sheet image is changed from the first position (the top) to the third position (the bottom), the layering order of the second sheet image is changed from the second position to the first position (the top), and the layering order of the third sheet image is changed from the third position (the bottom) to the second position. As a result of this, the sheet image layering unit 53 layers of the respective data in the order of the second image sheet, the third image sheet, and the first image sheet.

In this way, the second sheet image is displayed in full-screen on the display unit 17 as a display target, thereby enabling a display change from the second sheet image to the third image sheet. Next, in a case in which there is such a display change, the layering order of the second sheet image is changed from the first position (the top) to the third position (the bottom), the layering order of the third sheet image is changed from the second position to the first position (the top), and the layering order of the first sheet image is changed from the second position to the first position. As a result of this, the sheet image layering unit 53 layers each of data in the order of the third image sheet, the first image sheet, and the second image sheet in this order.

In this way, the third sheet image is displayed in full-screen on the display unit 17 as a display target, thereby enabling a display change from the third sheet image to the second image sheet. Next, in a case in which there is such a display change, the layering order of the third sheet image is changed from the first position (the top) to the third position (the bottom), the layering order of the first sheet image is changed from the second position to the first position (the top), and the layering order of the second sheet image is changed from the second position to the first position. As a result of this, the sheet image layering unit 53 layers of the respective data in the order of the first image sheet, the second image sheet, and the third image sheet in this order. In other words, as a result in which the display change of the sheet images is repeated, the layering order circulates (rotates) and returns to the initial state.

As described above, although an example in which the display change of the sheet images is performed in the layering order of descending order from the top to the bottom is described, it is similarly possible to realize display changing of the sheet images in the layering order of the ascending order from the bottom to the top.

The active/hold switching operation receiving unit 54 receives an operation of switching between the active state in which a change of a display area within a sheet image is permitted and the hold state in which a change of a display area within a sheet image is prohibited and a change of a display area between sheet images is permitted (hereinafter, referred to as “active/hold switching operation”). Then, the active/hold switching operation receiving unit 54 notifies a state of the active/hold switching operation thus received (whether it is the active state or the hold state) to the switching unit 56.

In the present embodiment, the active/hold switching operation receiving unit 54 receives a pressing operation on a dedicated software button displayed on the display unit 17 as the active/hold switching operation (more specifically, a touch operation done on an area corresponding to a display area of the software button on a touch screen of the input unit 16). It should be noted that such an operation is called hereinafter “software button pressing operation”.

The display change operation receiving unit 55 receives an operation to instruct a change of display contents on the display unit 17 (hereinafter, referred to as “display change operation”). Then, the display change operation receiving unit 55 executes control to switch an output destination of the switching unit 56 based on the contents of the display change operation thus received.

In the present embodiment, the display change operation receiving unit 55 receives gesture operations that are arbitrarily set such as an operation of moving a touch operation position, specifically, flick operation, slide operation, swipe operation, for example, as a display change operation.

The switching unit 56 inputs the contents of the display change operation from the display change operation receiving unit 55 and switches an output destination based on the control of the active/hold switching operation receiving unit 54. More specifically, the switching unit 56 switches the output destination to the in-sheet displaying area change unit 57 in a case of being the active state and notifies the contents of the display change operation from the display change operation receiving unit 55 to the in-sheet display area change unit 57. On the other hand, the switching unit 56 notifies the output destination to the in-sheet display area change unit 57 in a case of being the hold state.

The in-sheet display area change unit 57 functions in a case of being the active state and executes control to change a display area on the display unit 17 within a sheet image of a display target (the layering order is the top) according to the contents of the display change operation notified from the switching unit 56.

In other words, there may be a case in which a size (resolution) of a sheet image is bigger than a screen size (resolution) of the display unit 17. In such a case, a part of the sheet image is displayed on the display area of the display unit 17. Therefore, which part within a sheet image of a display target (the top) is displayed on a display area is changed according to the contents of the display change operation.

The between-sheet display area change unit 58 functions in a case of being the hold state and executes control to change a display area of the display unit 17 between the sheet images according to the contents of the display change operation notified from the switching unit 56.

In other words, the between-sheet display area change unit 58 executes control to change the display area of the display unit 17 so as to gradually slide from the sheet image layered on the top to the sheet image layered subsequently.

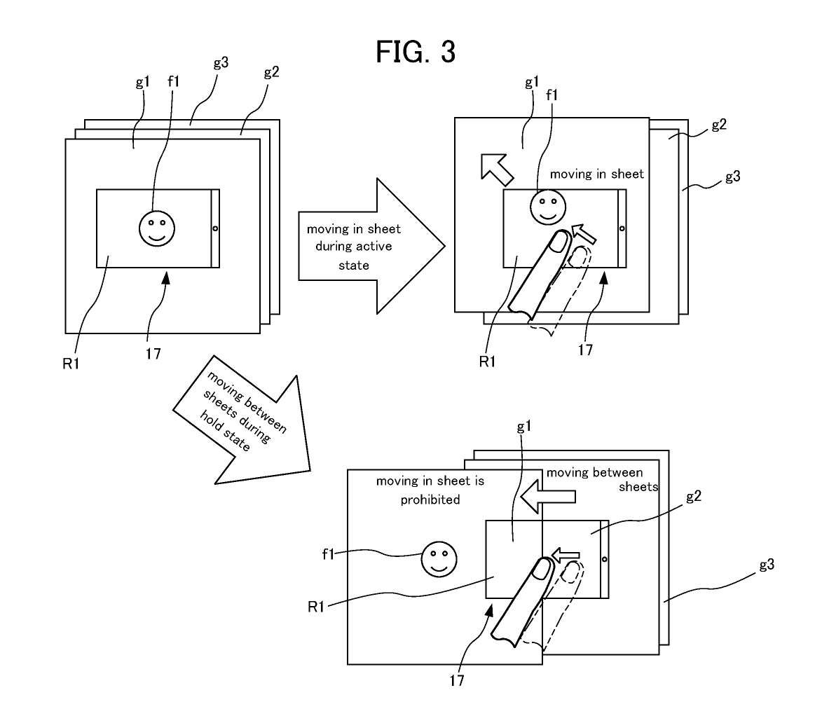

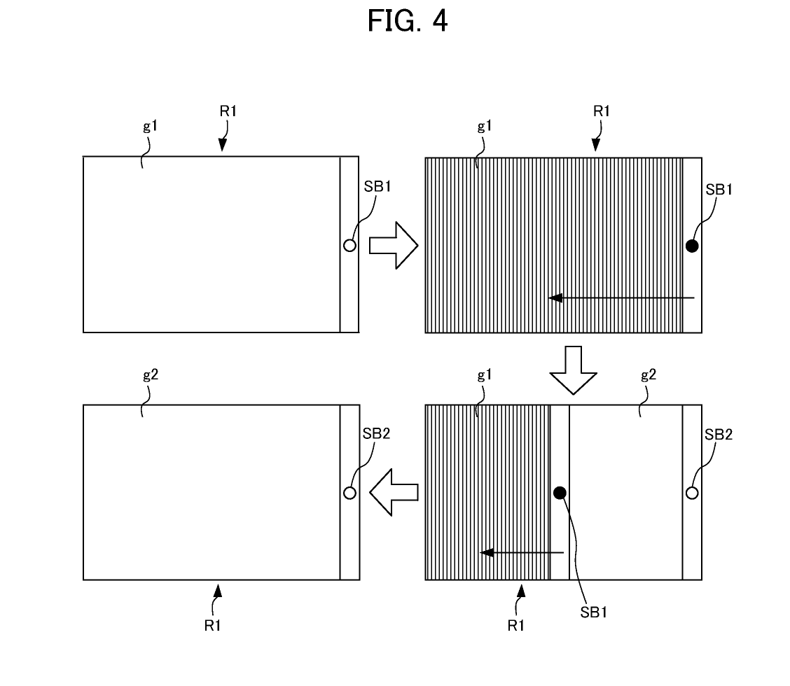

In the following, a change in a display area in a sheet image and a change in a display area between sheet images are described in detail with reference to FIGS. 3 and 4 in consideration of the difference therebetween.

FIG. 3 is a diagram showing respective outlines of a change in a sheet image and a change between sheet images on a display area in the active/hold display processing.

As shown in the upper left of FIG. 3, in the initial state, a first sheet image g1 to a third sheet image g3 are layered in this order from the top, and a partial area of the first sheet image g1 on the top (a center area in the present example) is displayed in a display area R1 on the display unit 17. In the example of FIG. 3, a face image f1 is located at a center portion of the first sheet image g1, and since a portion of the first sheet image g1 including the center portion is displayed in the display area R1 of the display unit 17, the face image f1 is displayed at the center of the display area R1 as a result.

Then, upon entering the active state, a change in a sheet image is permitted for a display target of the display area R1 on the display unit 17.

In this case, for example, as shown in the upper right drawing of FIG. 3, a touch operation (gesture operation) is performed to move a contact position, etc. of a finger on the touch screen of the input unit 16, as the display change operation. Then, as seen from the display area R1 on the display unit 17 (assuming that the display area R1 is fixed), the first sheet image g1 is moved in an upper left direction. As a result of this, a display target of the display area R1 on the display unit 17 is changed to a portion that is spaced apart in an upper left direction from a center portion of the first sheet image g1 (the distance of spacing depends on a moving distance of a gesture operation). It is visually recognized by a user such that the face image f1 moves from the center in an upper right direction in the display area R1 on the display unit 17, i.e. such that a display of the display area R1 on the display unit 17 is sequentially updated.

On the other hand, upon entering the hold state, for a display target of the display area R1 on the display unit 17, a change in a sheet image is prohibited and a change between sheet images is permitted.

In this case, for example, as shown in the lower right drawing of FIG. 3, a touch operation (gesture operation) is performed to move a contact position, etc. of a finger on the touch screen of the input unit 16, as the display change operation. Then, as seen from the display area R1 on the display unit 17 (assuming that the display area R1 is fixed), sliding is gradually performed in the left direction from the first sheet image g1 that is layered on the top to the second sheet image g2 that is layered subsequently.

FIG. 4 is a diagram showing an example of a screen transition at the time of a change between sheet images of a display area in the active/hold display processing.

The upper left drawing of FIG. 4 shows an initial state in which the first sheet image g1 is in the active state. In this case, if the display change operation (a gesture operation) is performed, a display target in the display area R1 is changed within the first sheet image g1.

Here, in the present embodiment, a software button SB1 for an operation to switch the active/hold state is arranged on both right and left end portions or either end portions of the display area R1 (in the present example, on a right end portion). When a pressing operation is performed on this software button SB1 (the software button pressing operation), the setting is changed from a state currently set to the other state, between the active state and the hold state.

On this occasion, a display mode of the software button SB1 is changed as well. In other words, a display mode showing the active state and a display mode showing the hold state are set in advance. It is acceptable so long as the first display mode and the second display mode are different from each other. In the present embodiment, a display with white color is employed for the first display mode and a display with black color is employed for the second display mode. In this way, since it is possible for a user to visually recognize whether a state currently set is the active state or the hold state, it is possible to prevent erroneous operation between the in-sheet moving and the between-sheet moving on a display area.

More specifically, the upper right drawing in FIG. 4 shows an aspect of being changed to the hold state since the pressing operation on the software button SB1 (the software button pressing operation) is performed in the initial state (upper left drawing).

Then, a gesture operation to slide a finger, etc. in the left direction on the touch screen of the input unit 16 is performed as the display change operation. Then, as shown in the lower right drawing in FIG. 4, the first sheet image g1 which is on the top is displayed so as to move sequentially in the left side on the display area R1 and, when the movement completes, the second sheet image g2 and a software button SB2 layered below the first sheet image g1 are displayed so as to appear therefrom.

Then, as shown in the lower left drawing in FIG. 4, when the rightmost end of the first sheet image g1 moves outside the display area R1, since the first sheet image g1 is entirely erased in the display area R1, a portion of the first sheet image g1 is displayed instead.

In this way, the change between sheet images in the display area R1 is performed. It should be noted that it is possible to change the second sheet image g2 to the hold state by way of the software button pressing operation on the software button SB2 so as to perform the change between sheet images again according to the layering state.

With reference to FIG. 2 again, the display image generation unit 59 generates data of an image displayed in a display area on the display unit 17 (hereinafter, referred to as “display image”) based on a control result of the in-sheet display area change unit 57 or the between-sheet display area change unit 58 and the layering relation managed by the sheet image layering unit 53.

In other words, the data of an image displayed in the display area R1 described with reference to FIGS. 3 and 4 is generated as data of a display image.

The display control unit 60 controls to display a display image generated as data by the display image generation unit 59 in a display area on the display unit 17.

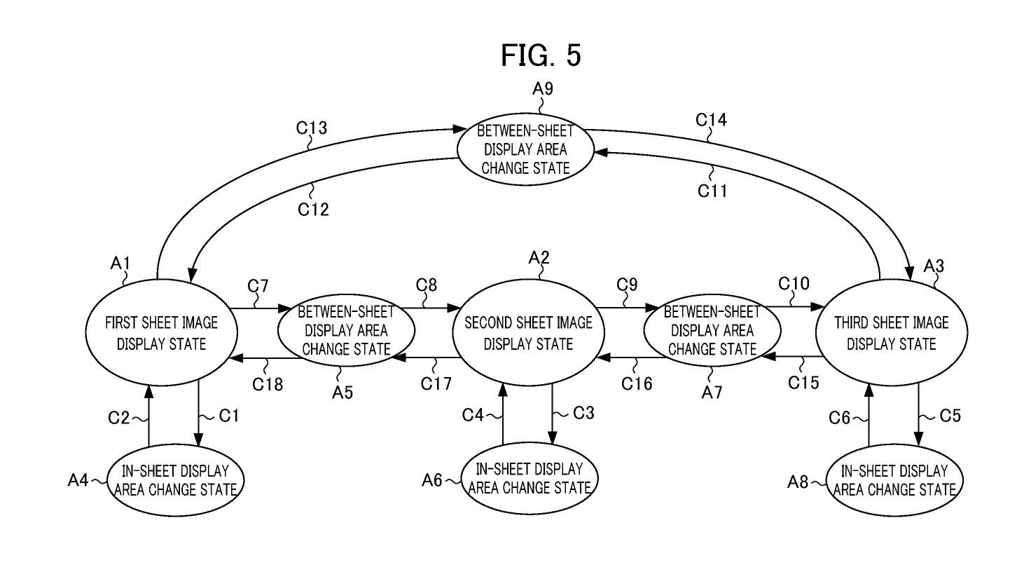

Then, with reference to FIG. 5, a transition of a screen state in a display area on the display unit 17 is described and an operation of a display controller 1 having the functional configuration of FIG. 2 is described.

FIG. 5 is a state transition diagram showing a screen transition of the display unit 17 in the active/hold display processing.

In FIG. 5, each state is represented by a single ellipse and is identified by reference symbols including “A” attached to the ellipses.

A state transition from one state to another state (including a case of a state remaining in the same state) is executed when a predetermined condition is satisfied (hereinafter, referred to as “a state transition condition”).

In FIG. 5, such a state transition condition is represented by reference symbols including “C” attached to arrows representing a transition from one state to another state.

Although the layered number of sheet images is assumed as three in FIG. 5, this is merely an example as described above.

As shown in FIG. 5, in the present embodiment, there is a state A1 in which a portion of the first sheet image is displayed (hereinafter, referred to as “first sheet image display state A1”, a state A2 in which a portion of the second sheet image is displayed (hereinafter, referred to as “second sheet image display state A2”), and a state A3 in which a portion of the third sheet image is displayed (hereinafter, referred to as “third sheet image display state S3”) as a static state.

On the other hand, there are states A4, A6, and A8 in which an in-sheet display area change in a display area is performed (hereinafter, referred to as “in-sheet display area change states A4, A6, and A8”) and states A5, A7, and A9 in which a between-sheet display area change in a display area is performed (hereinafter, referred to as “between-sheet display area change states A5, A7, and A9”) as a transient state.

More specifically, the abovementioned initial state is an active state in the first sheet image display state A1.

When a display change operation is received by the display change operation receiving unit 55 in the active state (initial state) in the first sheet image display state A1, the state transition condition C1 is satisfied.

Then, the state transitions to the in-sheet display area change state A4. In this case, as seen from the display area R1 on the display unit 17 (assuming that the display area R1 is fixed), the first sheet image is moved in the direction of the display change operation, as described with reference to the upper right drawing of FIG. 3. As a result of this, a portion of a sheet image as a display target in the display area R1 on the display unit 17 is changed.

When the display change operation receiving unit 55 ends receiving the display change operation, the state transition condition C2 is satisfied. Then, the state returns back to the first sheet image display state A1.

It should be noted that the transition from each sheet image display state (static state) to each in-sheet display area change state (transient state) is performed when a state transition condition similar to the state transition condition C1 is satisfied. Then, when a state transition condition similar to the state transition condition C2 is satisfied, the transition from each in-sheet display area change state to an original sheet image display state is performed.

Furthermore, when the display change operation is received by the display change operation receiving unit 55 in the hold state in the first sheet image display state A1, the state transition condition C7 is satisfied.

Then, the state transitions to the between-sheet display area change state A5. In this case, as seen from the display are R1 in the display unit 17 (assuming that the display area R1 is fixed), sliding is gradually performed in the left direction from the first sheet image that is layered on the top to the second sheet image that is layered subsequently, as described with reference to the lower right drawing in FIG. 3.

Then, when the display change operation receiving unit 55 continues to receive the display area change operation in the hold state at least a predetermined period of time, the state transition condition C8 is satisfied. Then, the state transitions to the second sheet between-image display state A2.

It should be noted that the transition from each sheet image display state (static state) to each between-sheet display area change state (transient state) is performed when a state transition condition similar to the state transition condition C7 is satisfied. Then, when a state transition condition similar to the state transition condition C8 is satisfied, a transition to a subsequent sheet image display state (static state) is performed.

It should be noted here that the between-sheet display area change state A9 is provided to allow a transition between the first sheet image display state A1 and the third sheet image display state A3. With such a configuration, a change between the sheet images in a circulating (rotating) manner is made possible, i.e. a circulating (rotating) change in the order of the first sheet image, the second sheet image, the third sheet image, the first sheet image, or in the order of the first sheet image, the third sheet image, the second sheet image, the first sheet image.

Next, a specific example of a display screen of the display unit 17 on which such a screen transition is performed is described.

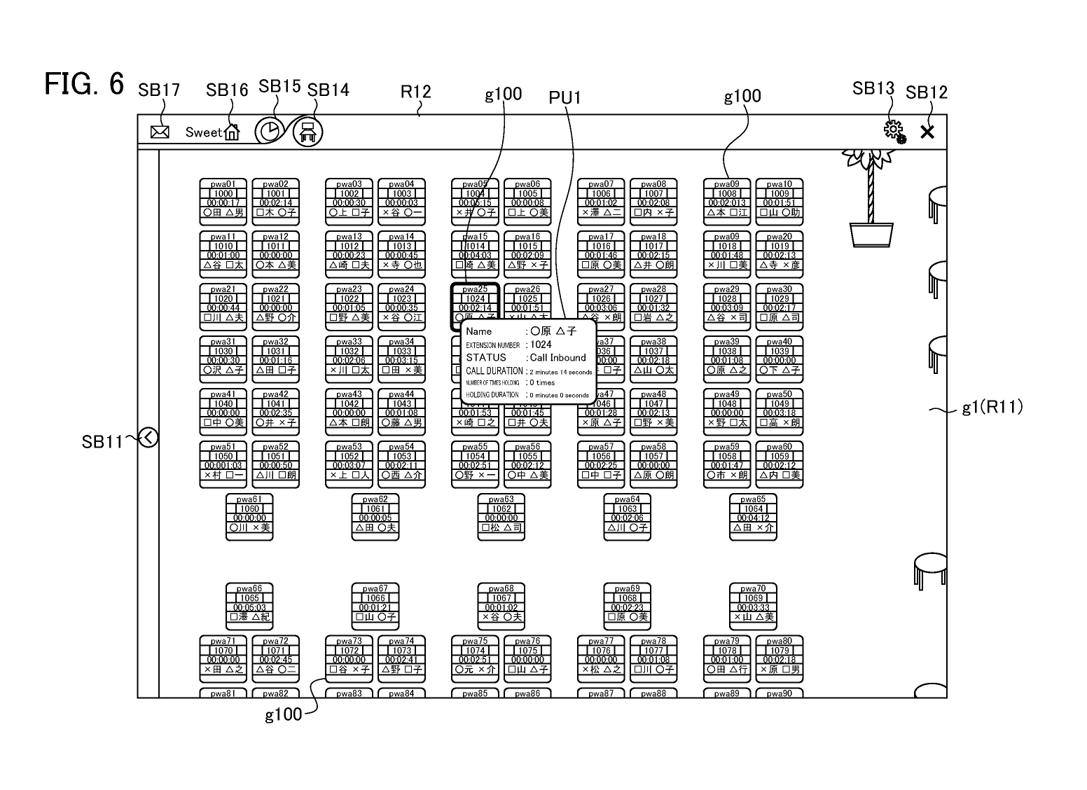

FIG. 6 is a diagram showing an example of a screen on the display unit 17 on which the first sheet image in an initial state is displayed in the active/hold display processing. It should be noted that an initial state in the example of FIG. 6 is a state in which a plurality of sheet images is selected by a user and, based on a selection state, the first sheet image is displayed as being in the active state. More specifically, a case is described below as an example in which a sheet image that schematically displays a phone operator who is currently on a call along with a seating arrangement is selected as a first sheet image g1, and a sheet image that schematically displays a change in call volume on a graph is selected as a second sheet image.

On the screen on the display unit 17, a display area R11 of the first sheet image g1 including a software button SB11 for the active/hold switching operation and a display area R12 are displayed.

Around the center in the screen of the display area R11, an image of the seating arrangement including a floor environment such as a plurality of seats, a house plant, tables, etc. is displayed as the first sheet image g1.

In an image g4 corresponding to seats, a part of information of phone operators arranged (“human resource ID”, “extension number”, “call duration”, and “name”) is displayed.

Furthermore, a seat image g100 serves as a software button and, when the software button pressing operation is performed on an arbitrary seat image g100 by a user, a pop-up image P01 is displayed as detailed information of a phone operator corresponding to the seat. At this moment, the seat image g100 for which the pop-up image P01 is displayed is highlighted. In the present embodiment, the highlighting of the seat image g100 is done by making a frame outline of a seat thick.

In addition, a software button SB11 for an operation to switch the active/hold state is arranged on a left end of the first sheet image g1 in the display area R11.

A plurality of software buttons SB12 to SB17 for performing various functional changes are arranged in the display area R12 located at the upper part of the screen.

The software button SB12 is a software button that exhibits a function to erase the first sheet image g1 that is currently displayed.

The software button SB13 is a software button for changing a display to a screen for various settings such as function settings.

The software button SB14 is an icon of the first sheet image g1 that is currently displayed.

The software button SB15 is an icon that corresponds to the second sheet image that is layered under the first sheet image g1. In other words, the number of icons corresponding to sheet images increases according to a layering state.

The second sheet image can be displayed by a user performing the software button pressing operation on the software button SB15.

The software button SB15 is an icon that corresponds to the second sheet image that is layered under the first sheet image g1.

The software button SB16 is a software button for changing a display to a home screen of the present application. On the home screen, it is possible to select a sheet image, move to a function setting screen, etc.

The software button SB16 is a software button for changing a screen of mail delivery.

Next, a display change operation on a screen display in such an initial state is described.

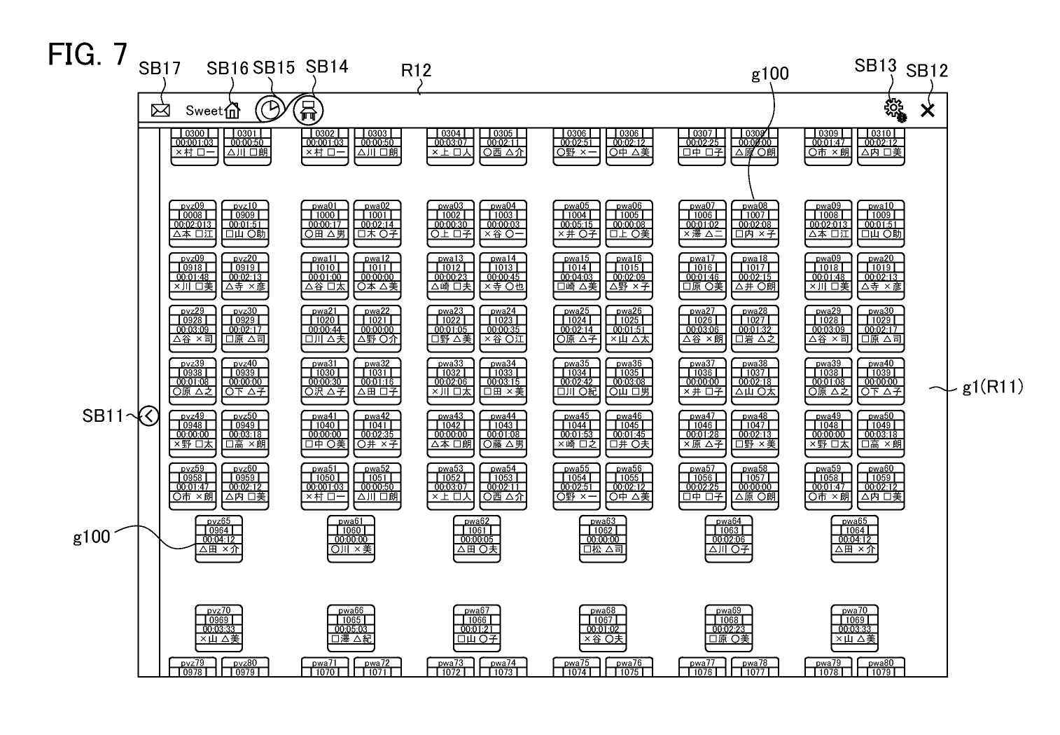

FIG. 7 is a diagram showing an example of a screen on a display unit on which a first sheet image g1 that is after a change of a display area in a sheet image is made in the active/hold display processing is displayed.

In such an initial state of FIG. 6, the first sheet image g1 is displayed and, since it is in the active state, a change in a sheet image is enabled.

The example of FIG. 7 shows a state in which a display change in a sheet is performed by performing a display change operation from the state of the screen display of FIG. 6. More specifically, it is a display screen that is after a gesture operation is performed as a display change operation in which a user slides a finger, etc. in the right direction on the touch screen of the input unit 16. As a result of this, the seating arrangement on the left side of the floor, which was hidden, is now displayed on the first sheet image g1.

Next, a case of transitioning from an initial state (the active state) to the hold state to perform a change between sheet images is described.

In a case of transitioning to the hold state, the software button pressing operation is performed on the software button SB11 (FIG. 6). Then, a change in a sheet image is prohibited. Subsequently, when a gesture operation is performed as a display change operation in which a user slides a finger, etc. in the right direction on the touch screen of the input unit 16, the screen displays a state of being during a display change between sheets.

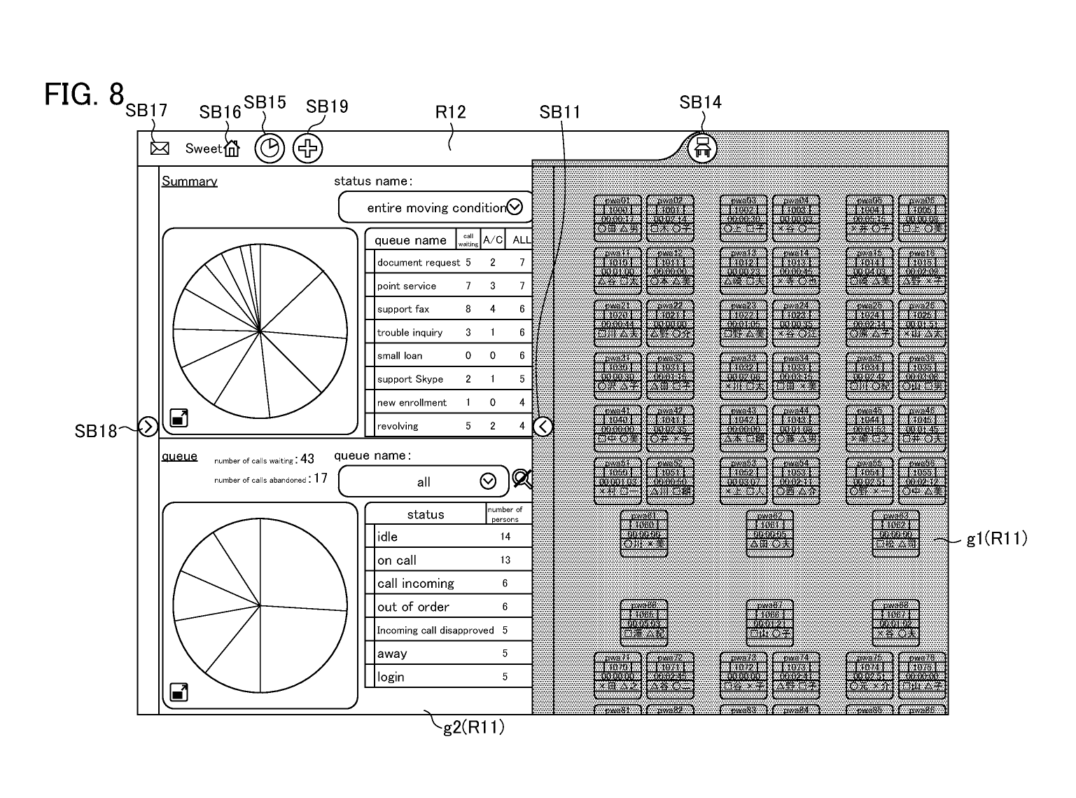

FIG. 8 is a diagram showing an example of a screen of a display unit which displays a state of being during a change of a display area between sheet images being made in the active/hold display processing. It should be noted that, in the present embodiment, a display is performed to invert the color on the first sheet image g1 in the hold state so that the active state and the hold state are visually discernable.

As shown in FIG. 8, in a screen of a state of being during a change of a display between sheets, the first sheet image g1 moves in the right direction by way of the user's gesture operation on the touch screen of the input unit 16. In the remaining display area R11 resulting from the first sheet image g1 moving in the right direction, the second sheet image g2 layered below the first sheet image g1 is displayed with the software button SB18 for an operation for switching the active/hold states. Furthermore, in the display area R12 in a status area, a new software button SB19 is displayed resulting from the first sheet image g1 moving in the right direction. The software button SB19 is a software button that functions to add a new sheet image.

If the user's gesture operation on the touch screen of the input unit 16 continues, an image relating to the display areas R11 and R12 is erased.

Furthermore, if the software button pressing operation is performed on the software button SB11 in the state shown in FIG. 8, the first sheet image g1 enters the active state, and a display change in a sheet of the first sheet image g1 or a display change in a sheet of the second sheet image g2 can be performed. In other words, in the display unit 17, the first sheet image g1 and the second sheet image g2 can be displayed at the same time so that, for example, the user can compare the first sheet image g1 with the second sheet image g2.

Next, a screen on the display unit 17 after a change of a display area between sheet images is performed in the active/hold display processing is described.

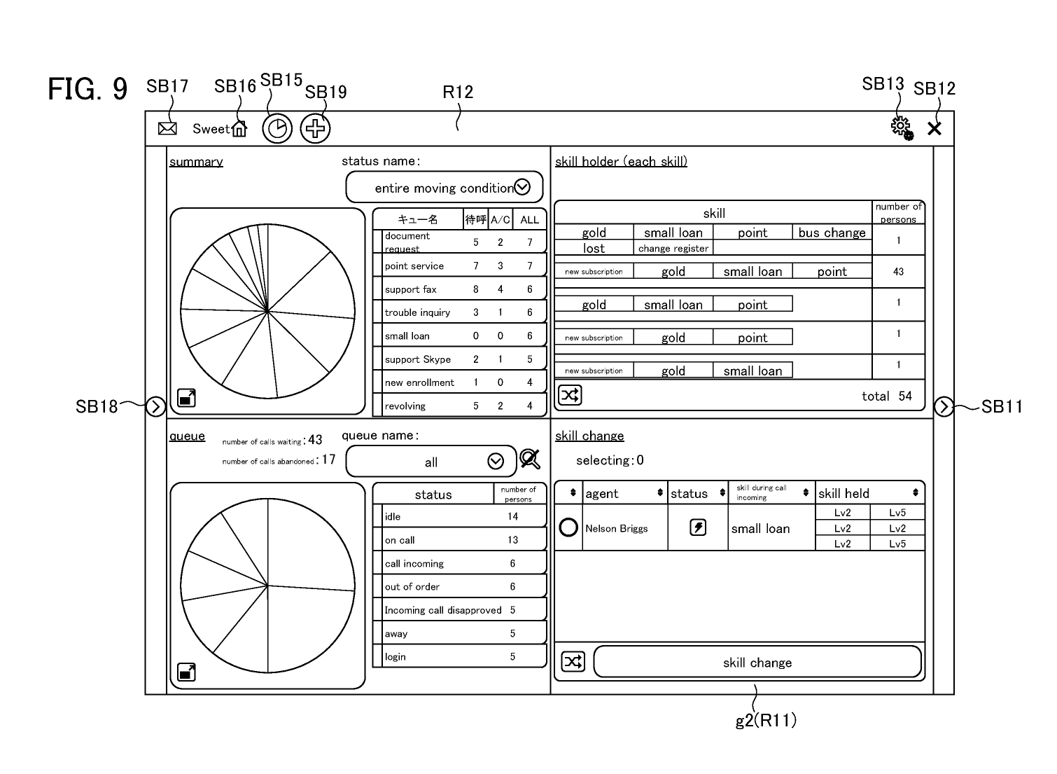

FIG. 9 is a diagram showing an example of a screen on the display unit after a change of a display area between sheet images is performed in the active/hold display processing.

In the example of FIG. 9, a sheet image is displayed which schematically shows a change in call volume by a graph as a second sheet image g2. It should be noted that, in the example of FIG. 9, the second sheet image g2 is displayed as being in the active state.

In the second sheet image g2 of the present example, a display area R11 is divided into four sections for each function.

In the display area R11, “Summary” field is located at an upper left, “Skill Holder (Each Skill)” field is located at an upper right, “Queue” field is located at a lower left, and “Skill Change” field is located at a lower right.

The field of “Summary” is an area for summarily displaying an entire condition. The field of “Summary” displays for example: a pie chart tallying overall moving conditions; tallied results of various “Queue names” including “Document request”, “Point service”, “Support Fax”, “Trouble inquiry”, “Small loan”, “Support Skype”, “New enrollment”, and “Revolving” (“call waiting”, “A/C”, “ALL”); and the number of persons corresponding to the various “Queue names”.

The field of “Skill holder (each skill)” is an area for summarily displaying skill-holding statuses of human resource currently working for each skill group. The field of “Skill holder (each skill)” groups a plurality of skills such as “gold”, “small loan” and “point” and displays the number of persons tallied for each group and the total number of persons, etc.

The field of “Queue” is an area for summarily displaying information relating to call waiting volume of human resource currently working. The field of “Queue” displays a pie chart tallying queues for each status, statuses forming the pie chart including “Idle”, “on call”, “call incoming”, “out of order”, “incoming call disapproved”, “away”, and “login”, and the number of persons corresponding to the statuses.

The field of “Skill change” is an area for displaying information relating to change of skill in a selectable manner. The field of “Skill change”, for example, displays icons for a selection box, icons for “status”, “incoming call skill”, and “skilled held” for “agents” selectable, and an icon for “Skill change” that allows a skill change.

Since it enters the active state in such a display screen, a display change in a sheet can be performed by the user's display change operation.

Furthermore, when the software button pressing operation is performed on the software button SB18 by the user, the second sheet image g2 enters the hold state and the display change between sheets can be performed. When the display change between sheets is performed, since an icon of another sheet image is not displayed in the display area R12, the first sheet image g1 is displayed in a circulating (rotating) manner.

On the other hand, when the software button pressing operation is performed on the software button SB11 by the user, it is possible to display again the first sheet image g1 by performing the display change operation on an area around the software button SB11.

Therefore, in the display controller 1, in a case of layering a plurality of sheet images and setting one sheet from among the plurality of sheet images as a display target, it is possible to realize a change of a display area in a sheet image and a change of a display area between sheet images with an intuitive operation without erroneous operation.

As described above, the display controller 1 includes the sheet image generation unit 52, the sheet image layering unit 53, the active/hold switching operation receiving unit 54, the display change operation receiving unit 55, the in-sheet display area change unit 57, the between-sheet display area change unit 58, the display image generation unit 59, and the display control unit 60.

The sheet image generation unit 52 generates data of a plurality of sheet images.

The sheet image layering unit 53 layers data of the plurality of sheet images generated by the sheet image generation unit 52 in a predetermined order.

The active/hold switching operation receiving unit 54 receives an operation for switching between the active state in which a change of a display area within a sheet image is permitted and the hold state in which a change of a display area within a sheet image is prohibited.

The display change operation receiving unit 55 receives an operation of instructing a change of display contents on the display unit 17.

The in-sheet display area change unit 57 functions in a case of being in the active state and changes an area displayed on the display unit 17 within an area of a sheet image that is layered on the top, based on the contents of the operation received by the display change operation receiving unit 55.

The between-sheet display area change unit 58 functions in a case of being in the hold state and changes an area displayed on the display unit 17 so as to gradually slide from a sheet image layered on the top to a subsequent layered sheet image, based on the contents of an operation received by the display change operation receiving unit 55.

In a case in which there is a change operation by the in-sheet display area change unit 57, the display image generation unit 59 generates an area changed within a sheet image on the top as a display image, and in a case in which there is a change operation by the between-sheet display area change unit 58, the display image generation unit 59 generates an image showing a state in which sliding is gradually performed from a sheet image layered on the top to a sheet image subsequently layered as data of a display image.

The display control unit 60 executes control to display a display image generated by the display image generation unit 59 on the display unit 17.

In this way, in the display controller 1, in a state in which there is a plurality of sheet images, moving within a sheet image during being displayed is permitted in the active state, and in a case of displaying a different sheet image, moving within a sheet image is prohibited as the hold state.

Therefore, in the display controller 1, in a case of layering a plurality of sheet images and setting one sheet from among the plurality of sheet images as a display target, it is possible to realize a change of a display area in a sheet image and a change of a display area between sheet images with an intuitive operation without erroneous operation.

The sheet image layering unit 53 layers data of a plurality of sheet images by changing the layering order so that a plurality of sheet images moves in a circulating manner each time a change operation by the between-sheet display area change unit 58 is performed.

Therefore, it is possible to display a sheet image that is already displayed by changing a display area of a new sheet image without performing an operation of pulling back the sheet image.

The display change operation receiving unit 55 receives a predetermined gesture operation as an operation of instructing a change of display contents on the display unit 17.

Therefore, in the display controller 1, it is possible to perform a change of a display area in a sheet image and a change of a display area between sheet images without losing operational feeling.

The present invention is not limited to the abovementioned embodiment; alterations, improvements, etc. within a scope that can achieve the object of the invention are included in the present invention.

In the abovementioned embodiment, although data of a sheet image is generated by data of a sheet image component stored in the sheet configuration information storage unit 81, the present invention is not limited thereto, and data of a sheet image may be generated based on data acquired from an external apparatus via the communication unit 19.

Furthermore, in the abovementioned embodiment, although various operations are received by operations on the input unit 16 configured with a touch screen, the present invention is not limited thereto. For example, in order to receive various operations, the input unit 16 may be configured with a unit other than a touch screen. In this case, it can be configured so as to receive operations corresponding to various types of the input unit 16, for example, click operations on information displayed on the display unit 17 and input operations via a keyboard.

In the abovementioned embodiment, a touch screen tablet is described as an example of the display controller 1, to which the present invention is applied; however, the present invention is not limited thereto in particular.

For example, the present invention can be applied to electronic devices having a display function in general. More specifically, for example, the present invention can be applied to a laptop personal computer, a television receiver, a video camera, a portable navigation device, a cellular telephone device, a portable gaming machine, etc.

The sequence of processing described above can be executed by hardware and/or software.

In other words, the functional configuration shown in FIG. 2 is merely an exemplification, and is not limited thereto in particular. In other words, it is sufficient for the display controller 1 to include a function capable of executing the aforementioned sequence of processing as a whole, and which functional block should be used to implement the function is not particularly limited to the example shown in FIG. 2.

A single functional block may be configured by a single piece of hardware, a single piece of software, or a combination thereof.

In a case in which a sequence of processing is executed by software, a program configuring the software is installed from a network or a recording medium into a computer, etc.

The computer may be a computer incorporated into specialized hardware. The computer may be a computer such as a general-purpose personal computer capable of executing various functions by installing various programs.

The storage medium containing such a program is not only configured by the removable medium 31 shown in FIG. 1 distributed separately from the device main body for supplying the program to the user, but may also be configured by a storage medium or the like provided to the user in a state incorporated in the device main body in advance. The removable medium 31 is configured by, for example, a magnetic disk (including a floppy disk), an optical disk, a magnetic optical disk, or the like. The optical disk is configured by, for example, a CD-ROM (Compact Disk-Read Only Memory), a DVD (Digital Versatile Disk), or the like. The magnetic optical disk is configured by an MD (Mini-Disk) or the like. The storage medium provided to the user in a state incorporated in the device main body in advance is configured by, for example, the ROM 12 shown in FIG. 1, a hard disk included in the storage unit 18 shown in FIG. 1 or the like, in which the program is recorded.

In the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely examples, and do not limit the technical scope of the present invention. Other various embodiments can be employed for the present invention, and various modifications with omissions and replacements are possible within a scope that does not depart from the spirit of the present invention. Such embodiments and modifications are included in the scope of the invention and the summary described in the present specification, and are included in the invention recited in the claims as well as an equivalent scope thereof.

What is claimed is:

1. A display controller comprising:
a sheet image generation unit that generates data of a plurality of sheet images;
a sheet image layering unit that layers, in a predetermined order, data of the plurality of sheet images generated by the sheet image generation unit;
a switching operation receiving unit that receives an operation to switch between an active state in which a change within a sheet image is permitted and a hold state in which the change is prohibited, for a display area of a predetermined display device;
a display change operation receiving unit that receives an operation to instruct a change of display contents of the display device;
an in-sheet display area change unit that functions in a case of being in the active state, and changes a display area of the display device within a range of a sheet image layered on the top, based on contents of the operation received by way of the display change operation receiving unit;
a between-sheet display area change unit that functions in a case of being in the hold state, and changes a display area of the display device so as to gradually slide from a sheet image layered on the top to a sheet image subsequently layered, based on contents of an operation received by the display change operation receiving unit;
a display image generation unit that, in a case of there being a change operation by way of the in-sheet display area change unit, generates a portion changed within a sheet image on the top as data of a display image, and in a case of there being a change operation by way of the between-sheet display area change unit, generates data of an image showing an aspect of gradually sliding from a sheet image layered on the top to a sheet image subsequently layered, as data of a display image; and
a display control unit that executes control to display the display image generated as data by the display image generation unit on a display area of the display device.

2. The display controller according to claim 1, wherein
the sheet image layering unit layers data of the plurality of sheet images by changing a layering order so that the plurality of sheet images moves in a circulating manner each time a change operation is performed by the between-sheet display area change unit.

3. The display controller according to claim 2, wherein
the display change operation receiving unit receives a predetermined gesture operation as the operation to instruct a change of display contents on the display unit.

4. The display controller according to claim 1, wherein
the display change operation receiving unit receives a predetermined gesture operation as the operation to instruct a change of display contents on the display unit.

5. A display control method executed by a display controller displaying a display image on a display device, comprising:
a sheet image generation step of generating data of a plurality of sheet images;
a sheet image layering step of layering, in a predetermined order, data of the plurality of sheet images generated by the sheet image generation unit;
a switching operation receiving step of receiving an operation to switch between an active state in which a change within a sheet image is permitted and a hold state in which the change is prohibited, for a display area of a predetermined display device;
a display change operation receiving step of receiving an operation to instruct a change of display contents of the display device;
an in-sheet display area change step of functioning in a case of being in the active state, and changing a display area of the display device within a range of a sheet image layered on the top, based on contents of the operation received by way of the display change operation receiving unit;
a between-sheet display area change step of functioning in a case of being in the hold state, and changing a display area of the display device so as to gradually slide from a sheet image layered on the top to a sheet image subsequently layered, based on contents of an operation received by the display change operation receiving unit;
a display image generation step of generating, in a case of there being a change operation by way of the in-sheet display area change unit, a portion changed within a sheet image on the top as data of a display image, and generating, in a case of there being a change operation by way of the between-sheet display area change unit, data of an image showing an aspect of gradually sliding from a sheet image layered on the top to a sheet image subsequently layered, as data of a display image; and
a display control step of executing control to display the display image generated as data by the display image generation unit on a display area of the display device.

6. A non-transitory computer-readable medium storing a program for causing a computer to display a display image on a display device and to execute:
a sheet image generation unit that generates data of a plurality of sheet images;
a sheet image layering unit that layers, in a predetermined order, data of the plurality of sheet images generated by the sheet image generation unit;
a switching operation receiving unit that receives an operation to switch between an active state in which a change within a sheet image is permitted and a hold state in which the change is prohibited, for a display area of a predetermined display device;
a display change operation receiving unit that receives an operation to instruct a change of display contents of the display device;
an in-sheet display area change unit that functions in a case of being in the active state, and changes a display area of the display device within a range of a sheet image layered on the top, based on contents of the operation received by way of the display change operation receiving unit;
a between-sheet display area change unit that functions in a case of being in the hold state, and changes a display area of the display device so as to gradually slide from a sheet image layered on the top to a sheet image subsequently layered, based on contents of an operation received by the display change operation receiving unit;
a display image generation unit that, in a case of there being a change operation by way of the in-sheet display area change unit, generates a portion changed within a sheet image on the top as data of a display image, and in a case of there being a change operation by way of the between-sheet display area change unit, generates data of an image showing an aspect of gradually sliding from a sheet image layered on the top to a sheet image subsequently layered, as data of a display image; and
a display control unit that executes control to display the display image generated as data by the display image generation unit on a display area of the display device.
